(19) United States
(12) Patent Application Publication
(10) Pub. No.: US 2013/0238529 A1
(43) Pub. Date: Sep. 12, 2013

(54) System and method for improving the minimization of the interest rate risk

(71) Applicant: Nicola Carcano, Viganello (CH)

(72) Inventor: Nicola Carcano, Viganello (CH)

(21) Appl. No.: 13/986,258

(22) Filed: Apr. 17, 2013

Related U.S. Application Data
(63) Continuation-in-part of application No. 12/461,360, filed on Aug. 10, 2009, now abandoned.
Application No. 12/461,360 is a continuation-in-part of application No. 12/461,150, filed on Aug. 3, 2009, now abandoned.

(51) Int. Cl. G06Q 40/06

(52) U.S. Cl. CPC G06Q 40/06
USPC 705/36 R

(57) ABSTRACT

A system for interest rate risk management, comprising: an input device, configured to receive as input a first group of data indicative of a first group of financial instruments to be protected; a second group of data indicative of a second group of financial instruments aimed at protecting said first group of financial instruments; and an interest rate risk minimization device, connected to said input device, configured to receive as input said first and second group of data, a data feed of current market prices of said first and second group of financial instruments, a set of parameters of a term structure model, and historical zero-coupon term structures of interest rates, and to generate historical model errors and, considering these errors, the optimal amount to be invested in each financial instrument which shall be used to protect the balance sheet or portfolio. The interest rate risk minimization device is further configured to generate a residual risk estimation.

This is a continuation-in-part of U.S. Ser. No. 12/461,360 filed on Aug. 10, 2009

The present invention relates generally to risk management. More specifically, the present invention relates to systems and methods for improving interest rate risk management for institutional investors, like banks, insurance companies and pension funds, and portfolio managers.

### BACKGROUND OF THE INVENTION

The level of interest in Liability Driven Investments (LDI) and, more generally, in accurate techniques of asset and liability management has grown up significantly over the last decade.

This follows a process of de-risking which has been implemented worldwide by many institutional investors.

Accordingly, the approaches to effectively hedge against interest rate risk have become significantly more sophisticated than the initial models based on duration and convexity.

Hedging interest rate risk relies on approximating the dynamics of the term structure of interest rates, that is the relationship between the level of a certain interest rate and its maturity, through a model considering a limited number of factors. This leads to a difference between the modeled and the actual dynamics of interest rates, which we will define as the model error.

The theories underpinning these approaches mostly rely on the concepts of key rate duration (KRD), of duration vectors (DV), generalized duration vectors (GDV) or on Principal Component Analysis (PCA).

Hedging based on PCA is one of the most common techniques used by institutional investors to minimize the basis risk from shifts in the yield curve. For this reason, this description of the invention is based on a PCA model. However, the key ideas of the invention can be applied also to key rate duration, duration vectors or M-vector models.

In the classical Asset Liability Management interest rate risk management problem, a portfolio of liabilities V is given, which at time t has a value of Vₜ and with cash flows that are grouped in m time buckets. The present value of the liabilities included in the i-th time bucket amounts is Aᵢ. In a context of portfolio management, portfolio V would simply represent the portfolio of investments which must be hedged.

For each of these time buckets, basis risk comes from unexpected shifts in the corresponding zero-coupon risk free rate R(t,Dₖ), where Dₖ indicates the duration and maturity of the time bucket.

In order to immunize the portfolio of liabilities within the following example, a hedging portfolio H is used and is composed of several coupon bonds y with cash flows that are grouped in n time buckets. The percentage of the present value of bond y represented by the cash flow with maturity Dₖ is indicated by ω_{y},k. Alternatively, the portfolio H could include other financial instruments, like interest rate swaps, bond futures, or interest rate futures.

The optimal amount to be invested in a specific coupon bond y is indicated by Φ_{y}, which is the final value to obtain by the resolution of the problem.

Usually hedging strategies assume the so-called self-financing constraint:

$${\sum }_{y = 1}^{M + 1} {φ}_{y , t} = {H}_{t} = {V}_{t} \qquad ( 2. )$$

In PCA-hedging models as used in the prior art, the set of equations to solve in order to obtain the optimal weights Φy is defined as follows:

$${\sum }_{y = 1}^{M + 1} {φ}_{y , t} {\sum }_{k = 1}^{n} {c}_{lk} {D}_{k} {ω}_{y , k , t} = {\sum }_{k = 1}^{m} {c}_{lk} {D}_{k} {A}_{k , t} \qquad ( 5. )$$

where cₗₖ represents the sensitivity of the zero-coupon rate of maturity Dₖ to the change in the l-th principal component and M represents the number of considered principal components and normally is two or three. Obviously, equation (5) would need to be adjusted if other financial instruments, like interest rate swaps, bond futures, or interest rate futures are included within the hedging portfolio H. These adjustments rely on well-known techniques.

This equation must be true for each principal component l. Equation (5.) ensures that the sensitivity of the two portfolios V and H to the dynamics of each principal component is equal.

In theory, PCA with three principal components (traditionally identified as the level, the steepness, and the curvature of the term structure) should improve the quality of hedging, since it allows to hedge also against changes in the curvature of the yield curve. However, empirical evidence exists suggesting that hedging based on PCA should rely rather on two principal components than on three.

Additional empirical evidence suggests that also other models which should in theory allow to better capture the dynamics of the yield curve do not necessarily lead to better hedging.

In KRD-hedging models as used in the prior art, the set of equations to solve in order to obtain the optimal weights Φy is defined as follows:

$${\sum }_{k = 1}^{n} {\sum }_{y = 1}^{M + 1} {φ}_{y , t} {ω}_{y , k , t} {c}_{l , k}^{KRD} {D}_{k} = {\sum }_{k = 1}^{m} {A}_{k , t} {c}_{l , k}^{KRD} {D}_{k} \qquad ( 5. a )$$

where c^{KRD}_{l,k} represents the sensitivity of the zero-coupon rate of maturity Dₖ to the change in the l-th key rate and M represents the number of considered key rates and normally is two or three. This equation must be true for each key rate l. Equation (5.a) ensures that the sensitivity of the two portfolios V and H to the dynamics of each key rate is equal.

A third approach relies on GDV-hedging models as used in the prior art, where the set of equations to solve in order to obtain the optimal weights Φy is defined as follows:

$${\sum }_{k = 1}^{n} {\sum }_{y = 1}^{M + 1} {φ}_{y , t} {ω}_{y , k , t} {D}_{k}^{χ ( l )} = {\sum }_{k = 1}^{m} {A}_{k , t} {D}_{k}^{χ ( l )} \qquad ( 5. b )$$

where Dₖ^{X(l)-l} represents the sensitivity of the zero-coupon rate of maturity Dₖ to the change in the l-th risk factor and M represents the number of considered risk factors and normally is two or three. This equation must be true for each risk factor l. Equation (5.b) ensures that the sensitivity of the two portfolios V and H to the dynamics of each risk factor is equal.

The DV approach is a special case of the GDV approach where X(l) has been set equal to l.

The size of the hedging error is influenced by the interaction of two main factors: the model error, that is the difference between the modeled and the actual dynamics of the yield curve, and the level of exposure of the overall portfolio, represented by the sum of the assets and the liabilities, to the model errors.

A higher exposure to model errors could outbalance the positive effect of a more sophisticated yield curve model capable of reducing the size of these errors.

In the state of art, traditional hedging based on PCA or on other models does not control the level of exposure to the model errors.

### SUMMARY OF THE INVENTION

The aim of the present invention is to provide a new system and method for interest rate risk management overcoming the above mentioned drawbacks.

Within this aim, an object of the present invention is to introduce a generalized hedging model able to control the overall exposure to the model errors and reduce residual interest rate risk.

Another object of the invention is to provide a rigorous estimate of residual risk.

This aim and other objects which will become better apparent hereinafter are achieved by a system for interest rate risk management (100), comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon termstructures of interest rates;
   wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
   wherein said interest rate risk minimization device is further configured to solve equation:

$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ [ {\sum }_{k = 1}^{n} {c}_{lk} {D}_{k} {w}_{y , k , t} ] [ {\sum }_{k = 1}^{max [ m , n ]} {c}_{lk} {D}_{k} ( {\sum }_{j = 1}^{M + 1} {φ}_{j , t} {w}_{j , k , t} - {A}_{k , t} ) ] ++ {\sum }_{k = 1}^{n} {θ}_{k}^{2} {c}_{lk}^{2} {D}_{k}^{2} {w}_{y , k , t} [ {\sum }_{j = 1}^{M + 1} {φ}_{j , t} {w}_{j , k , t} - {A}_{k , t} ] \} - {μ}_{t} = 0$$

to obtain μₜ and said optimal amount (Φ_{y}),
wherein Dₖ is a zero-coupon rate of maturity, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model, w_{y,k,t} and w_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
wherein the ratio θₖ, the volatility σ_{C} of the modeled rate shifts and the model errors σ_{ε} are defined as

$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

Another aim and other objects which will become better apparent hereinafter are achieved by a system for interest rate risk management (100), comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon termstructures of interest rates;
   wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
   wherein said interest rate risk minimization device is further configured to solve the following equation for each bond j included in the hedging portfolio to obtain μₜ and said optimal amount (Φ_{y}):

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

wherein the factor F^{l} represents the l-th key zero rate change, c^{KRD}ₗₖ represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
the volatility of the model errors σ_{ε} can be defined as in equation

$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

Another aim and other objects which will become better apparent hereinafter are achieved by a system for interest rate risk management (100), comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon term structures of interest rates;
   wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
   wherein said interest rate risk minimization device is further configured to solve the following equation for each bond j included in the hedging portfolio to obtain μₜ and said optimal amount (Φ_{y}):

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - t} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

wherein F^{l} represents the l-th risk factor change, Dₖ^{X(l)-l} represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation

$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

Another aim and other objects which will become better apparent hereinafter are achieved by a method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
   solving, by means of said interest rate risk minimization device, equation:

$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ [ {\sum }_{k = 1}^{n} {c}_{lk} {D}_{k} {w}_{y , k , t} ] [ {\sum }_{k = 1}^{max [ m , n ]} {c}_{lk} {D}_{k} ( {\sum }_{j = 1}^{M + 1} {φ}_{j , t} {w}_{j , k , t} - {A}_{k , t} ) ] ++ {\sum }_{k = 1}^{n} {θ}_{k}^{2} {c}_{lk}^{2} {D}_{k}^{2} {w}_{y , k , t} [ {\sum }_{j = 1}^{M + 1} {φ}_{j , t} {w}_{j , k , t} - {A}_{k , t} ] \} - {μ}_{t} = 0$$

to obtain μₜ and said optimal amount (Φ_{y}).
   wherein Dₖ is a zero-coupon rate of maturity, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model, w_{y,k,t} and w_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
   wherein the ratio θₖ, the volatility σ_{C} of the modeled rate shifts and the model errors σ_{ε} are defined as

$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} ..$$

Another aim and other objects which will become better apparent hereinafter are achieved by a method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
   solving, by means of said interest rate risk minimization device the following equation for each bond j included in the hedging portfolio to obtain μₜ and said optimal amount (Φ_{y}):

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

wherein the factor F^{l} represents the l-th key zero rate change, c^{KRD}ₗₖ represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
the volatility of the model errors σ_{ε} can be defined as in equation

$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

Another aim and other objects which will become better apparent hereinafter are achieved by a method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
   solving, by means of said interest rate risk minimization device the following equation for each bond j included in the hedging portfolio to obtain μₜ and said optimal amount (Φ_{y}):

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

wherein F^{l} represents the l-th risk factor change, Dₖ^{X(l)-l} represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation

$$\begin{matrix}{{σ}_{ɛ} ( t , {D}_{k} )}^{2} ≡ {θ}_{k}^{2} {{σ}_{C} ( t , {D}_{k} )}^{2} \\ = {θ}_{k}^{2} {\sum }_{l = 1}^{M} {c}_{lk}^{2} {E [ {C}_{t}^{l} ]}^{2} .\end{matrix}$$

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 is block diagram depicting a system for interest rate risk management in accordance with the invention.

FIG. 2 is block diagram depicting a preferred embodiment of the invention, based on the PCA hedging model.

### DESCRIPTION OF THE PREFERRED EMBODIMENTS

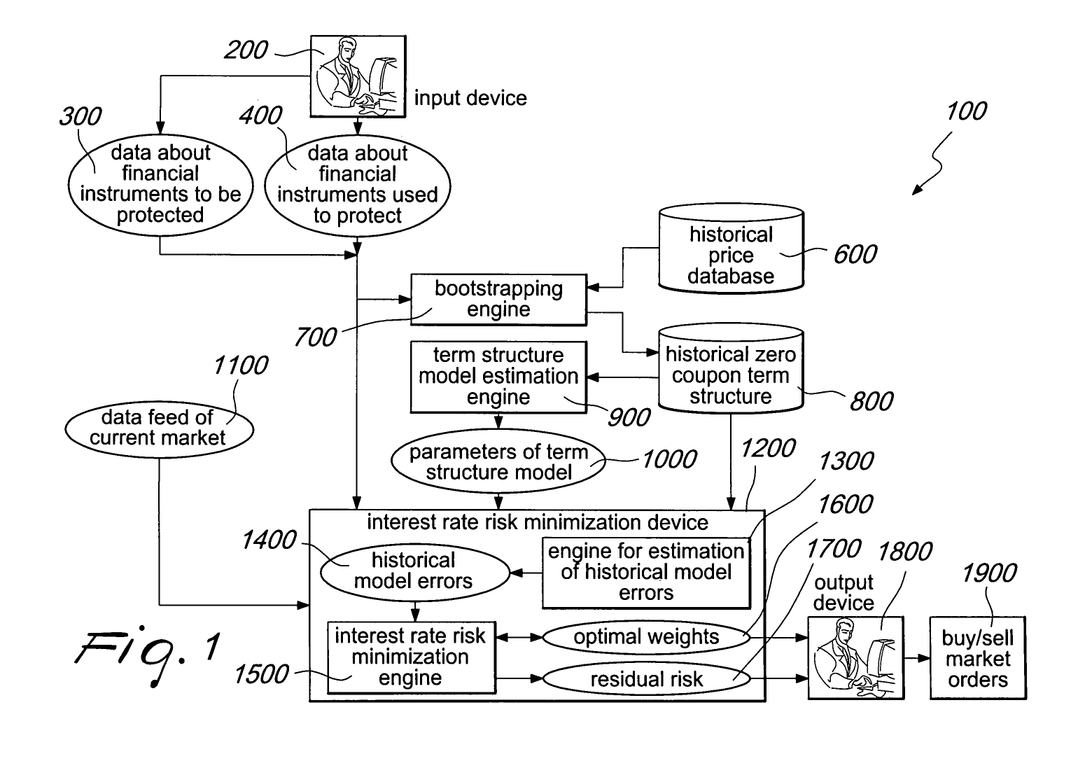

A schematic diagram of a system for interest rate risk management according to the present invention is shown in FIG. 1.

System 100 comprises an input device 200, an historical price database 600, a bootstrapping engine 700, a historical zero-coupon term structure of interest rates 800, a term structure model estimation engine 900, an interest rate risk minimization device 1200, and an output device 1800.

Input device 200 comprises any device suited to feed system 100 with data, for instance a keyboard or a file reader. Data to be fed to system 100 through input device 200 comprises a first group 300 of data about financial instruments contained in the balance sheet or portfolio to be protected, a second group 400 of data that contains the information related to the financial instruments which shall be used to protect the balance sheet or portfolio.

The historical price database 600 may contain historical prices of the financial instruments underlying the term structure of interest rates. For example, for the US risk-free term structure, the CRSP Database for US Treasuries can be used.

The bootstrapping engine 700 is a module that cooperates with the historical price database 600 in order to construct another data structure, historical zero-coupon term structures of interest rates (including the current term structure) 800, starting from the historical market prices of the financial instruments extracted by database 600.

The term structure model estimation engine 900 is a module that estimates the parameters of a model explaining the dynamics of the term structure of interest rates, relying on the historical zero-coupon term structure of interest rates 800. Thus the term structure model estimation engine 900 produces as output a set of parameters 1000 of a model explaining the dynamics of the term structure of interest rates.

In a preferred embodiment this model relies on principal component analysis. However, the invention can also be applied to other models explaining the dynamics of the term structure which are commonly used for minimizing interest rate risk, such as M-vector models, key rate duration models, generalized duration vector or duration vector.

The interest rate risk minimization device 1200 receives as input first 300, and second 400 groups of data, historical zero-coupon term structures of interest rates 800, parameters 1000 and current market prices 1100 of the financial instruments, that is a data feed of current market prices that allows to price the financial instruments which are involved in the current interest rate risk minimization problem.

The interest rate risk minimization device 1200 comprises an engine for estimation of historical model errors 1300; this engine, based on the information extracted from the historical zero-coupon term structures of interest rates 800 obtained by the bootstrapping engine 700 and the set of term structure parameters 1000, generates the model errors 1400; the model errors are represented by the difference between actual zero-coupon interest rate changes and changes explained by the adopted model of the term structure.

The interest rate risk minimization device 1200 also comprises an interest rate risk minimization engine 1500, suited to minimize interest rate risk considering the model errors 1400 estimated by the model errors engine 1300, the set of term structure parameters 1000, and current market prices 1100. The main minimization results are optimal weights 1600 for the financial instruments used to protect the balance sheet or portfolio against interest rate risk, and residual risk estimation 1700.

The calculated optimal weights 1600 indicate the optimal amount to be invested in each financial instrument which shall be used to protect the balance sheet or portfolio.

The residual risk estimation 1700 can be calculated based on the model errors 1400 estimated by the model errors engine 1300 and on the calculated optimal weights 1600, and is an essential estimate in order to determine if the considered strategy for minimizing interest rate risk is satisfactory or not.

The output device 1800 receives the optimal weights 1600, which can be used to generate buy and sell market orders 1900, and the residual risk estimation 1700 generated by the interest rate risk minimization device 1200.

In a preferred embodiment, the invention is based on a PCA hedging model. In this model the model error ε for a martingale zero-coupon rate of duration Dₖ can be defined as:

$$d R ( t , {D}_{k} ) ≡ {\sum }_{l = 1}^{M} {c}_{lk} {C}_{t}^{l} + ɛ ( t , {D}_{k} ) \qquad ( 1. )$$

where dR(t,Dₖ) represents an unexpected shift in the corresponding zero-coupon risk-free rate, Cₗₜ represents the change in the l-th principal component between time t and t+1 and cₗₖ continues to represent the sensitivity of the zero-coupon rate of maturity Dₖ to this change.

In the hedging based on PCA of current state of art the expected hedging error due to the modeled behavior of interest rates is equal to zero, so the error terms ε in equation (1.) are ignored; while in the PCA-hedging of this invention the error terms ε in equation (1.) should be considered within the minimization of the expected immunization error.

The way in which the error terms ε in equation (1.) are considered within the minimization can be simple but also sophisticated. According to a simple approach, the volatility of the model errors σ_{ε} is assumed to be proportional to the volatility σ_{C} of the modeled rate shifts, so that their ratio θₖ is defined as:

$$\begin{matrix}{{σ}_{ɛ} ( t , {D}_{k} )}^{2} ≡ {θ}_{k}^{2} {{σ}_{C} ( t , {D}_{k} )}^{2} \\ = {θ}_{k}^{2} {\sum }_{l = 1}^{M} {c}_{lk}^{2} {E [ {C}_{t}^{l} ]}^{2}\end{matrix} \qquad ( 4. )$$

For the sake of simplicity, θₖ is assumed to be constant over time.

There is large empirical evidence that—for holding periods not longer than one month—the effect of rate changes on the return provided by a zero bond can be plausibly approximated by its duration Dₖ. On this basis, it is possible to approximate the overall unexpected return provided by the combination of the two portfolios V and Has follows:

$${ψ}_{t} \approx - {\sum }_{y = 1}^{M + 1} {φ}_{y , t} {\sum }_{k = 1}^{n} d R ( t , {D}_{k} ) {D}_{k} {ω}_{y , k , t} + {\sum }_{k = 1}^{m} d R ( t , {D}_{k} ) {D}_{k} {A}_{k , t} \qquad ( 7. )$$

which, applying definition (1.), may be written as:

$${ψ}_{t} \approx {\sum }_{y = 1}^{M + 1} {φ}_{y , t} {\sum }_{k = 1}^{n} [ {\sum }_{l = 1}^{M} {c}_{lk} {C}_{t}^{l} + ɛ ( t , {D}_{k} ) ] {D}_{k} {ω}_{y , k , t} + {\sum }_{k = 1}^{m} [ {\sum }_{l = 1}^{M} {c}_{lk} {C}_{t}^{l} + ɛ ( t , {D}_{k} ) ] {D}_{A} {A}_{k , t} \qquad ( 8. )$$

Since the residuals of a PCA have means equal to zero and are independent from the principal components, the expected squared value of the unexpected return is:

$$E [ {ψ}_{t}^{2} ] \approx E {\{ {\sum }_{l = 1}^{M} {C}_{t}^{l} [ {\sum }_{k = 1}^{m} {c}_{lk} {D}_{k} {A}_{k , t} - {\sum }_{y = 1}^{M + 1} {φ}_{y , t} {\sum }_{k = 1}^{n} {c}_{lk} {D}_{k} {ω}_{y , k , t} ] \}}^{2} ++ E {\{ {\sum }_{k = 1}^{m} ɛ ( t , {D}_{k} ) {D}_{k} {A}_{k , t} - {\sum }_{y = 1}^{M + 1} {φ}_{y , t} {\sum }_{k = 1}^{n} ɛ ( t , {D}_{k} ) {D}_{k} {ω}_{y , k , t} \}}^{2} \qquad ( 9. )$$

Assuming that the model error for a given rate k is independent from the model errors for all other rates and applying the independence among the principal components as well as definition (4.), the last equation becomes:

$$E [ {ψ}_{t}^{2} ] \approx {\sum }_{l = 1}^{M} E [ {( {C}_{t}^{l} )}^{2} ] \{ {[ {\sum }_{k = 1}^{max [ m , n ]} {c}_{lk} {D}_{k} [ {A}_{k , t} - {\sum }_{y = 1}^{M + 1} {φ}_{y , t} {ω}_{y , k , t} ] ]}^{2} ++ {\sum }_{k = 1}^{max [ m , n ]} {θ}_{k}^{2} {c}_{lk}^{2} {{D}_{k}^{2} [ {A}_{k , t} - {\sum }_{y = 1}^{M + 1} {φ}_{y , t} {ω}_{y , k , t} ]}^{2} \} \qquad ( 10. )$$

In order to minimize the equation (10.) subjecting to the self-financing constraint, the first partial derivatives of the following Lagrangian function is set equal to zero, where μₜ is the Lagrange multiplier:

$$L ( {ϕ}_{t} , {μ}_{t} ) = E ( {ψ}_{t}^{2} ) - {μ}_{t} ( {\sum }_{y = 1}^{M + 1} {φ}_{y , t} - {H}_{t} ) \qquad ( 11. )$$

Setting the first derivatives with respect to the amounts Φ_{y} equal to zero leads to following equation:

$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ [ {\sum }_{k = 1}^{n} {c}_{lk} {D}_{k} {ω}_{y , k , t} ] [ {\sum }_{k = 1}^{max [ m , n ]} {c}_{lk} {D}_{k} ( {\sum }_{j = 1}^{M + 1} {φ}_{j , t} {ω}_{j , k , t} - {A}_{k , t} ) ] ++ {\sum }_{k = 1}^{n} {θ}_{k}^{2} {c}_{lk}^{2} {D}_{k}^{2} {ω}_{y , k , t} [ {\sum }_{j = 1}^{M + 1} {φ}_{j , t} {ω}_{j , k , t} - {A}_{k , t} ] \} - {μ}_{t} = 0 \qquad ( 12. )$$

This set of hedging equations must be applied to every y.

The set of hedging equations (12.) is subject to the self-financing constraint (2.).

The PCA-hedging equation of the current state of art (5.) is a special case of the generalized hedging strategy (12.) of the present invention, specifically, it is the case assuming no model errors.

Accordingly, the improvement of PCA-hedging model presented in this invention within this particular embodiment consists in the term of equations (12.) including θₖ.

Within this term, θₖ represents the size of the expected model errors for rate R(t,Dk), whereas the exposure of the hedging strategy to these errors is represented by:

$${\sum }_{l = 1}^{M} E [ {( {C}_{t}^{l} )}^{2} ] {c}_{lk}^{2} {{D}_{k}^{2} [ {A}_{k , t} - {\sum }_{y = 1}^{M + 1} {φ}_{y , t} {ω}_{y , k , t} ]}^{2} \qquad ( 6. )$$

The purpose of the term of equations (12.) including θₖ is to introduce a penalty for the exposure to model errors.

In this way the generalized PCA hedging implements a trade-off between the precision of matching the sensitivity of portfolio V to each principal component, that is the exclusive goal of traditional PCA-hedging, and the level of exposure to model errors.

In a second preferred embodiment, the invention is based on a KRD hedging model. In this model the model error ε for a martingale zero-coupon rate of duration Dₖ can be defined as:

$$d R ( t , {D}_{k} ) ≡ {\sum }_{l = 1}^{M} {c}_{lk}^{KRD} {F}_{t}^{l} + ɛ ( t , {D}_{k} )$$

where in this case the factor F^{l} represents the l-th key zero rate change and c^{KRD}ₗₖ represents the sensitivity of the zero-coupon rate of maturity Dₖ to this change which can be defined in different ways, for example, like in Nawalkha, Soto, and Beliaeva, Interest Rate Risk Modeling. John Wiley & Sons, 2005.

Following the same approach described above for the PCA approach, the expected squared value of the unexpected return can be approximated by:

$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , k , t} ) {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$

where the volatility of the model errors σ_{ε} can be defined as in equation (4.) or in a more sophisticated way. If we construct the Lagrangian function as:

$$L ( {ϕ}_{t} , {μ}_{t} ) = E ( {ψ}_{t}^{2} ) - {μ}_{t} ( {\sum }_{y = 1}^{M + 1} {φ}_{y , t} - {H}_{t} )$$

and we set its first derivatives equal to zero, we obtain the self-financing constraint and the following equations for each bond j included in the hedging portfolio:

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

The optimal weights φ_{y} to be invested in each bond can be calculated based on the last set of equations.

Yet in a third preferred embodiment, the invention is based on a GDV hedging model. In this model the model error □ for a martingale zero-coupon rate of duration Dk can be defined as:

$$dR ( t , {D}_{k} ) ≡ {\sum }_{l = 1}^{M} \frac{{F}_{t}^{l}}{{D}_{k}^{1 - χ ( l )}} + ɛ ( t , {D}_{k} )$$

where in this case the factor F^{l} represents the l-th risk factor change and Dₖ^{X(l)-l} represents the sensitivity of the zero-coupon rate of maturity Dₖ to this change.

Following the same approach described above for the PCA approach, the expected squared value of the unexpected return can be approximated by:

$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , v , t} ) {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] ++ {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$

where the volatility of the model errors σ_{ε} can be defined as in equation (4.) or in a more sophisticated way. If we construct the Lagrangian function as:

$$L ( {ϕ}_{t} , {μ}_{t} ) = E ( {ψ}_{t}^{2} ) - {μ}_{t} ( {\sum }_{y = 1}^{M + 1} {φ}_{y , t} - {H}_{t} )$$

and we set its first derivatives equal to zero, we obtain the self-financing constraint and the following equations for each bond j included in the hedging portfolio:

$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$

The optimal weights φ_{y} to be invested in each bond can be calculated based on the last set of equations.

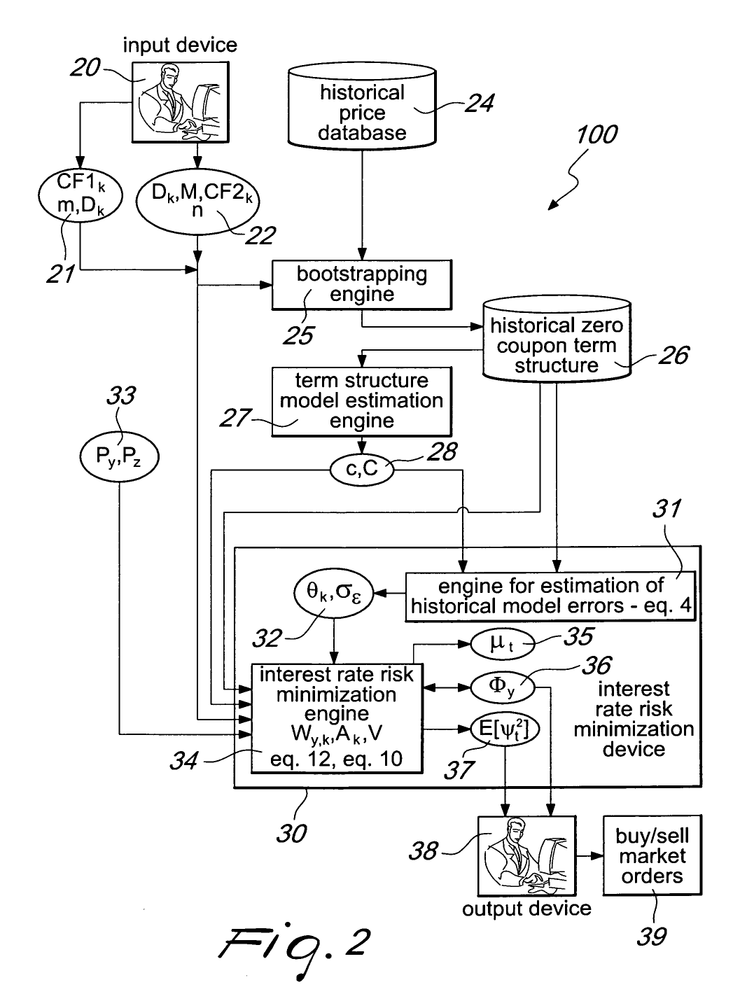

A preferred embodiment of the invention based on PCA hedging model is shown in FIG. 2.

As in the general case depicted in FIG. 1, system 100 comprises an input device 20 through which a user may insert a first group of data 21 about the financial instruments contained in the balance sheet or portfolio to be protected; this first group comprises the cash-flows CF1ₖ of these financial instruments, the number m of time buckets in which the cash flow are grouped and the duration Dₖ of the time bucket.

A second group of data 22 is inserted, which is related to the financial instruments y which shall be used to protect the balance sheet or portfolio; this second group comprises the number n of time buckets in which the cash flow of these financial instruments are grouped, the cash-flows CF2ₖ of these financial instruments, and the duration Dₖ of the time bucket.

Using the inserted values 21 and 22 and the data extracted from the historical price database 24, the bootstrapping engine 25 builds the historical zero coupon term structures 26.

Based on historical zero coupon term structures 26, the term structure model estimation engine 27 calculates the parameters 28 of a PCA model explaining the dynamics of the term structure of interest rates. Specifically, the obtained parameters 28 are the value Cₗₜ, that represents the change in the l-th principal component between time t and t+1, and cₗₖ, that represent the sensitivity of the zero-coupon rate of maturity Dₖ to this change.

In this example, the historical zero coupon term structures 26 and the parameters 28, Cₗₜ and cₗₖ, are sent as input to the historical model errors engine 31; the historical model errors engine 31 is configured to solve the equation (4) and to produce as output the model errors 32, that contains the value of σ_{ε} and θₖ.

Market prices of the financial instruments which shall be used to protect the balance sheet or portfolio, P_{y} as well as of any listed security which might be included in portfolio V, P_{z} are retrieved from market data providers in 33.

All the values inserted and updated, Dₖ, m, n, M, CF1ₖ, CF2ₖ, P_{y}, P_{z} and all calculated values Cₗₜ, cₗₖ, θₖ, are sent as input to the interest rate risk minimization engine 34, that relying on the current zero-coupon term structure included in 26 first calculates Aₖ, V as well as the percentage w_{y,k} of the present value of bond y represented by the cash flow with maturity Dₖ, and then, using these calculated values, solves the equation 12 and produces as output the value 35 of the Lagrange multiplier μₜ and the optimal weights 36, that is Φ_{y}.

The interest rate risk minimization engine 34 further uses the estimated values 36 to solve the equation 10 and obtains as output the residual risk estimation 37, that is E[Ψₜ²].

The output device 38 receives the values Φy 36 and E[Ψₜ²] 37 in order to implement buy and sell orders 39 on the markets as in the general case depicted in FIG. 1.

In this preferred embodiment the term structure model estimation engine 900 is based on PCA hedging but, as shown in the general embodiment of FIG. 1, this engine can be based also on alternative models, such as M-vector models, key rate duration models or duration vector models. The same logic used in this specific embodiment is maintained in the engine for estimation of historical model errors 1300 while equations (10) and (12) in the interest rate risk management minimization engine 34 are derived, as already shown above, starting from a revised version of equation (1) based on the adopted term structure model and then following the same steps shown above.

It has been shown that the invention fully achieves the intended aim and objects, since it allows to adopt a generalized hedging model able to control the overall exposure to the model errors and reduce residual interest rate risk.

In particular, the interest rate risk minimization engine as disclosed in the present invention allows to control the exposure to model errors in a hedging strategy.

This is a new feature that is ignored by current applications known in the art for interest rate risk management.

An important result obtained by a system according to this invention is an average reduction in the hedging errors of 35%.

In the particular case of the PCA hedging model, the generalized model proposed in this invention permits to the 3-component PCA to outperform 2-component PCA. Similar advantages can also be expected for the KRD and GDV models.

Another advantage obtained by a system according to this invention is the estimation of the residual risk in order to determine if the considered strategy for minimizing interest rate risk is satisfactory or not. This is another new feature of this invention ignored by current applications minimizing interest rate risk which assume residual risk to be zero.

Clearly, several modifications will be apparent to and can be readily made by the skilled in the art without departing from the scope of the present invention.

Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the skilled in the art.

What is claimed is:

1. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon termstructures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is further configured to solve equation:
$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ \begin{matrix}[ {\sum }_{k = 1}^{n} {c}_{lk} {D}_{k} {w}_{y , k , t} ] [ {\sum }_{k = 1}^{m ax [ m , n ]} {c}_{lk} {D}_{k} ( {\sum }_{j = 1}^{M + 1} {φ}_{j , t} {w}_{j , k , t} - {A}_{k , t} ) ] ++ \\ {\sum }_{k = 1}^{n} {θ}_{k}^{2} {c}_{lk}^{2} {D}_{k}^{2} {w}_{y , k , t} [ {\sum }_{j = 1}^{M + 1} {φ}_{j , t} {w}_{j , k , t} - {A}_{k , t} ]\end{matrix} \} - {μ}_{t} = 0$$
to obtain μₜ and said optimal amount (Φ_{y}),
wherein Dₖ is a zero-coupon rate of maturity, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model, w_{y,k,t} and w_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
wherein the ratio θₖ, the volatility σ_{C} of the modeled rate shifts and the model errors σ_{ε} are defined as
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

2. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon termstructures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is further configured to solve the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein the factor F^{l} represents the l-th key zero rate change, c^{KRD}ₗₖ represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

3. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon termstructures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is further configured to solve the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein F^{l} represents the l-th risk factor change, Dₖ^{x(l)-l} represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2}$$

4. The system according to claim 1, 2 or 3 wherein said interest rate risk minimization device comprises an engine for estimation of said historical model errors, configured to receive as input said a set of parameters of a term structure model and information extracted from said historical zero-coupon term structures of interest rates and to generate said historical model errors.

5. The system according to claim 4, wherein said interest rate risk minimization device comprises an interest rate risk minimization engine, configured to receive as input said first group of data indicative of a first group of financial instruments to be protected, said second group of data indicative of a second group of protecting financial instruments, said historical model errors, the set of parameters of a term structure model, said historical zero-coupon term structures of interest rates, and said current market prices and to generate said optimal amount (Φ_{y}) for investment in each financial instrument of said second group of financial instruments for protecting said first group of financial instruments, and said residual risk estimation (E[Ψₜ²]).

6. The system according to claim 5, further comprising a historical price database, storing historical prices of financial instruments underlying the historical zero-coupon term structures of interest rates, and a bootstrapping engine, connected to said input device and to said historical price database, configured to generate said historical zero-coupon term structures of interest rates.

7. The system according to claim 6, further comprising a term structure model estimation engine, receiving said historical zero-coupon term structures of interest rates, and configured to generate said set of parameters of a term structure model.

8. The system according claim 7, further comprising an output device, configured to receive as input said optimal amount for investment in each financial instrument of said second group of financial instruments for generating buy and sell market orders, and said residual risk estimation.

9. The system according to claim 8, wherein said term structure model relies on Principal Component Analysis.

10. The system according to claim 1, wherein said interest rate risk minimization device is further configured to solve an equation:
$$E [ {ψ}_{t}^{2} ] \approx {\sum }_{l = 1}^{M} E [ {( {C}_{t}^{l} )}^{2} ] \{ {[ {\sum }_{k = 1}^{m ax [ m , n ]} {c}_{lk} {D}_{k} [ {A}_{k , t} - {\sum }_{y = 1}^{M + 1} {φ}_{y , t} {w}_{y , k , t} ] ]}^{2} ++ {\sum }_{k = 1}^{m ax [ m , n ]} {θ}_{k}^{2} {c}_{lk}^{2} {{D}_{k}^{2} [ {A}_{k , t} - {\sum }_{y = 1}^{M + 1} {φ}_{y , t} {w}_{y , k , t} ]}^{2} \}$$
to obtain said residual risk estimation (E[Ψₜ²]).

11. The system according to claim 2 wherein said interest rate risk minimization device is further configured to solve an equation:
$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , v , t} ) {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] ++ {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$
to obtain said residual risk estimation (E[Ψₜ²]).

12. The system according to claim 3, wherein said interest rate risk minimization device is further configured to solve an equation:
$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , v , t} ) {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] ++ {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$
to obtain said residual risk estimation (E[Ψₜ²]).

13. A method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
solving, by means of said interest rate risk minimization device, equation:
$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ [ {\sum }_{k = 1}^{n} {c}_{lk} {D}_{k} {w}_{y , k , t} ] [ {\sum }_{k = 1}^{m ax [ m , n ]} {c}_{lk} {D}_{k} ( {\sum }_{j = 1}^{M + 1} {φ}_{j , t} {w}_{j , k , t} - {A}_{k , t} ) ] ++ {\sum }_{k = 1}^{n} {θ}_{k}^{2} {c}_{lk}^{2} {D}_{k}^{2} {w}_{y , k , t} [ {\sum }_{j = 1}^{M + 1} {φ}_{j , t} {w}_{j , k , t} - {A}_{k , t} ] \} - {μ}_{t} = 0$$
to obtain μₜ and said optimal amount (Φ_{y}),
wherein Dₖ is a zero-coupon rate of maturity, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model, w_{y,k,t} and w_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
wherein the ratio θₖ, the volatility σ_{C} of the modeled rate shifts and the model errors σ_{ε} are defined as
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

14. A method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
solving, by means of said interest rate risk minimization device the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein the factor F^{l} represents the l-th key zero rate change, c^{KRD}ₗₖ represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2}$$

15. A method for interest rate risk management, comprising:
receiving as input into an input device, a first group of data about a first group of financial instruments to be protected and a second group of data about a second group of financial instruments protecting said first group of financial instruments;
receiving as input into an interest rate risk minimization device connected to said input device: said first and second group of data; a data feed of current market prices of said first and second group of financial instruments; a set of parameters of a term structure model; and historical zero-coupon term structures of interest rates;
generating, by means of said interest rate risk minimization device: historical model errors; an optimal amount (Φ_{y}), obtained as a function of said historical model errors, for investment in each financial instrument of said second group of financial instruments for protecting said first group of financial instruments; and a residual risk estimation (E[Ψₜ²]); and
solving, by means of said interest rate risk minimization device the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein F^{l} represents the l-th risk factor change, Dₖ^{X(l)-l} represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

16. The method according to claim 13, 14 or 15, further comprising
storing, in a historical price database, historical prices of financial instruments underlying the historical zero-coupon term structures of interest rates; and
generating, by a bootstrapping engine, connected to said input device and to said historical price database, said historical zero-coupon term structures of interest rates.

17. The method according to claim 16, further comprising generating, by a term structure model estimation engine, receiving said historical zero-coupon term structure of interest rates, said set of parameters of a term structure model.

18. The method according to claim 17, wherein said step of generating historical model errors comprises receiving as input, by an engine adapted to estimate historical model errors comprised in said interest rate risk minimization device, said set of parameters of a term structure model and information extracted from said historical zero-coupon term structures of interest rates.

19. The method according to claim 18, wherein said step of generating said residual risk estimation (E[Ψₜ²]) comprises receiving as input, by an interest rate risk minimization engine comprised in said interest rate risk minimization device, said historical model errors and generating said optimal amount (Φ_{y}) for investment in each financial instrument of said second group of financial instruments.

20. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon term structures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation;
wherein said interest rate risk minimization device comprises an engine for estimation of historical model errors which is configured to solve an equation:
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2}$$
to obtain θₖ.
wherein θₖ is a ratio, the σ_{C} is the volatility the modeled rate shifts, σ_{ε} is a model error, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model.

21. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon term structures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is configured to solve an equation:
$$E [ {ψ}_{t}^{2} ] \approx {\sum }_{l = 1}^{M} E [ {( {C}_{t}^{l} )}^{2} ] \{ {[ {\sum }_{k = 1}^{max [ m , n ]} {c}_{lk} {D}_{k} [ {A}_{k , t} - {\sum }_{y = 1}^{M + 1} {φ}_{y , t} {w}_{y , k , t} ] ]}^{2} ++ {\sum }_{k = 1}^{max [ m , n ]} {θ}_{k}^{2} {c}_{lk}^{2} {{D}_{k}^{2} [ {A}_{k , t} - {\sum }_{y = 1}^{M + 1} {φ}_{y , t} {w}_{y , k , t} ]}^{2} \}$$
to obtain said residual risk estimation (E[Ψₜ²]),
wherein said interest rate risk minimization device is further configured to solve an equation:
$$\frac{\partial L ( {ϕ}_{t} , {μ}_{t} )}{\partial {φ}_{y , t}} \approx \approx 2 {\sum }_{l = 1}^{M} E [ {( {C}_{t}^{l} )}^{2} ] \{ [ {\sum }_{k = 1}^{n} {c}_{lk} {D}_{k} {w}_{y , k , t} ] [ {\sum }_{k = 1}^{max [ m , n ]} {c}_{lk} {D}_{k} ( {\sum }_{j = 1}^{M + 1} {φ}_{j , t} {w}_{j , k , t} - {A}_{k , t} ) ] ++ {\sum }_{k = 1}^{n} {θ}_{k}^{2} {c}_{lk}^{2} {D}_{k}^{2} {w}_{y , k , t} [ {\sum }_{j = 1}^{M + 1} {φ}_{j , t} {w}_{j , k , t} - {A}_{k , t} ] \}$$
to obtain μₜ and said optimal amount (Φ_{y}), wherein Dₖ is a zero-coupon rate of maturity, C^{l}ₜ represents the change in the l-th principal component between time t and t+1, cₗₖ represents the sensitivity of the zero-coupon rate of maturity Dₖ to this change, said C^{l}ₜ and cₗₖ being the set of parameters of a term structure model, w_{y,k,t} and w_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and
wherein the ratio θₖ, the volatility σ_{C} of the modeled rate shifts and the model errors σ_{ε} are defined as
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

22. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon term structures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is further configured to solve the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein the factor F^{l} represents the l-th key zero rate change, c^{KRD}ₗₖ represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2} .$$

23. A system for interest rate risk management, comprising:
an input device, configured to receive as input a first group of data indicative of a first group of financial instruments to be protected; a second group of data indicative of a second group of financial instruments for protecting said first group of financial instruments; and
an interest rate risk minimization device, connected to said input device, configured to receive as input said first and second group of data, a data feed of current market prices of said first and second group of financial instruments, a set of parameters of a term structure model, and historical zero-coupon term structures of interest rates;
wherein said interest rate risk minimization device is further configured to generate: historical model errors;
an optimal amount (Φ_{y}), obtained as a function of said historical model errors, for investment in each financial instrument of said second group of financial instruments for protecting said first group of financial instruments; and a residual risk estimation (E[Ψₜ²]);
wherein said interest rate risk minimization device is further configured to solve the following equation for each bond j included in the hedging portfolio to obtain μₜ and said optimal amount (Φ_{y}):
$$2 {\sum }_{k = 1}^{n} ( [ {\sum }_{v = 1}^{n} {ω}_{j , v , t} {D}_{v} {D}_{k} {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] + {{σ}_{ɛ} ( t , {D}_{k} )}^{2} {D}_{k}^{2} {ω}_{j , k , t} ] [ {\sum }_{y = 1}^{M + 1} {φ}_{y , t} {ω}_{y , k , t} - {A}_{k , t} ] ) = {μ}_{t}$$
wherein F^{l} represents the l-th risk factor change, Dₖ^{X(l)-l} represents the sensitivity of the zero-coupon rate of maturity Dₖ to this change, ω_{y,k,t} and ω_{j,k,t}, indicate the percentage of the present value of bond y and j, respectively, represented by the cash flow with maturity D_{k,}_{^{A}}_{,k,t} is the value of the liabilities included in the k-th time bucket amounts, μₜ is the Lagrange multiplier and the volatility of the model errors σ_{ε} can be defined as in equation
$${{σ}_{ɛ} ( t , {D}_{k} )}^{2} ≡ {θ}_{k}^{2} {{σ}_{C} ( t , {D}_{k} )}^{2} = {θ}_{k}^{2} {\sum }_{l = 1}^{M} {c}_{lk}^{2} {E [ {C}_{t}^{l} ]}^{2}$$

24. The method according to claim 13, further comprising solving, by means of said interest rate risk minimization device, an equation:
$$E [ {ψ}_{t}^{2} ] \approx {\sum }_{l = 1}^{M} E [ {( {C}_{t}^{l} )}^{2} ] \{ {[ {\sum }_{k = 1}^{max [ m , n ]} {c}_{lk} {D}_{k} [ {A}_{k , t} - {\sum }_{y = 1}^{M + 1} {φ}_{y , t} {w}_{y , k , t} ] ]}^{2} ++ {\sum }_{k = 1}^{max [ m , n ]} {θ}_{k}^{2} {c}_{lk}^{2} {{D}_{k}^{2} [ {A}_{k , t} - {\sum }_{y = 1}^{M + 1} {φ}_{y , t} {w}_{y , k , t} ]}^{2} \}$$
to obtain said residual risk estimation (E[Ψₜ²]).

25. The method according to claim 14, further comprising solving, by means of said interest rate risk minimization device, an equation:
$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , v , t} ) {E}_{t} [ {\sum }_{l = 1}^{M} {c}_{lk}^{KRD} {F}_{t}^{l} {\sum }_{h = 1}^{M} {c}_{hv}^{KRD} {F}_{t}^{h} ] ++ {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$
to obtain said residual risk estimation (E[Ψₜ²]).

26. The method according to claim 15, further comprising solving, by means of said interest rate risk minimization device, an equation:
$${{E}_{t} [ {ψ}_{t} ]}^{2} \approx {\sum }_{k = 1}^{n} {\sum }_{v = 1}^{n} ( {D}_{k} {A}_{k , t} - {\sum }_{y = 1}^{M + 1} {φ}_{y , t} {D}_{k} {ω}_{y , k , t} ) ( {D}_{v} {A}_{v , t} - {\sum }_{y = 1}^{M + 1} {φ}_{y , t} {D}_{v} {ω}_{y , v , t} ) {E}_{t} [ {\sum }_{l = 1}^{M} {D}_{k}^{χ ( l ) - 1} {F}_{t}^{l} {\sum }_{h = 1}^{M} {D}_{v}^{χ ( h ) - 1} {F}_{t}^{h} ] ++ {\sum }_{k = 1}^{n} {{σ}_{ɛ} ( t , {D}_{k} )}^{2} {( {D}_{k} {A}_{k , t} - {\sum }_{y = 1}^{M + 1} {φ}_{y , t} {D}_{k} {ω}_{y , k , t} )}^{2}$$
to obtain said residual risk estimation (E[Ψₜ²]).
